(19) United States
(12) Patent Application Publication
(10) Pub. No.: US 2014/0028208 A1
(43) Pub. Date: Jan. 30, 2014

(54) LIGHT SOURCE ELECTRONIC TRANSFORMER

(71) Applicants: Márton Nedermann, Budapest (HU); Ferenc Fazekas, Piliscsaba (HU); Géza Zoltán Cseh, Budapest (HU)

(72) Inventors: Márton Nedermann, Budapest (HU); Ferenc Fazekas, Piliscsaba (HU); Géza Zoltán Cseh, Budapest (HU)

(21) Appl. No.: 13/561,660

(22) Filed: Jul. 30, 2012

(51) Int. Cl. H05B 37/02

(52) U.S. Cl. CPC H05B 37/0281
USPC 315/200 R

(57) ABSTRACT

Apparatus and methods for a light source electronic transformer. In an embodiment, a lamp includes a light source and an electronic ballast. The electronic ballast includes a main power converter, a controllable starter circuit, a transformer, a ballast control integrated circuit (IC) connected to the controllable starter circuit and having an output connected to the transformer, and an IC power converter connected to the transformer and having an output connected to the ballast control IC. When the light source is to be switched ON, the controllable starter circuit receives power from the main power converter and provides a high energy output. The ballast control IC outputs a power control signal to the transformer that illuminates the light source and the transformer to provide supply power to the IC power converter. The electronic ballast is configured such that after the light source illuminates the controllable starter circuit powers OFF.

### BACKGROUND

Electronic transformers are now commonly used in place of wire wound step down transformers in order to provide the correct supply for widely used low voltage (generally 12V) filament lamps such as halogen lamps. Such electronic transformers have a small size and weight, include fault protection circuitry, and are safe due to low output voltage. Such low voltage electronic transformers have become popular for use with low voltage lighting applications and are commonly built directly into a lamp unit. The range of available products ranges from very small, for example 2-3 Watts (W) units for an LED lamp (capable of driving only a single LED in a 2-39/lamp), to 3009/units capable of driving up to six 50 W lamps.

Power MOSFETs driven by a control integrated circuit (IC) that incorporates additional functionality are in use as electronic converters for low voltage filament lamp applications. For example, the IR21611 control IC is an 8-pin chip package manufactured by the international Rectifier Company, and is a dedicated half-bridge driver IC for a halogen convertor or “electronic transformer” for medium and high end performance, low voltage lighting applications.

FIG. 1 illustrates a typical Halogen-type IC controlled converter 100 utilizing the IR2161 chip 1102, which application includes both oscillator and shut-down circuitry. The IR2161 provides tow and high side output drives HO and LO for the half-bridge MOSFETs labeled as Q1 104 and Q2 106. The output from the half bridge is connected to a high frequency stepdown transformer 108, which supplies approximately 12 Vrms (without dimming) at the output 110 to drive the lamps.

At switch-on, the frequency sweeps from a high frequency of about 125 kHz down to the converter's normal operating frequency over a period of approximately 1 second. Leakage inductance in the transformer causes the output voltage at the lamp to start at a reduced value and to gradually increase to the 12V nominal level to reduce inrush current at switch on. When the lamp is cold the filament resistance is tower which tends to cause high inrush currents that can cause shorter filament lifetime and false tripping of a shutdown circuit.

An electronic transformer is normally required to provide a reasonably consistent output voltage over a range of toads. Thus, the IC controlled converter of FIG. 1 senses the load through the current sense resistor RCS 112 and increases the frequency as the load is reduced to compensate for the output transformer load regulation. There is also some modulation of the frequency to reduce the size and cost of the EMC filtering components required. The IR2 161 chip 102 allows the convertor to be dimmed externally with a standard phase cut dimmer.

Although the IC controlled converter 100 of FIG. 1 purportedly extends lamp life due to its soft start and output voltage shift (load regulation) compensation features, such ballast control IC circuits typically take input power directly from high voltage lines, and thus the power dissipation can be very high. When the electronic transformer ballast control IC circuit is integrated into a lamp, such high heat dissipation can cause a very serious thermal management problem which may result in significantly shorter lamp lifetime.

Thermal measurements were made on a test-panel of the IC controlled converter 100 of FIG. 1. In particular, a 230 VAC, 50 Hz mains voltage and a leading edge type dimmer at 50% were used, and the following results were obtained in an open air condition. With reference to the IC controlled converter 100 of FIG. 1, the measured temperature of the RD resistor 114 was equal to 124.3° C. (with rated parameters of 270 Ohms, 3 Watts); the measured temperature of the RS resistor 116 was equal to 73.1° C. (with rated parameters of 120 kOhms, 1 Watt); and the measured temperature of the CD capacitor 118 was equal to 50.8° C. (with rated parameters of 330 nF, 400 Volts). Such high temperature, high-heat dissipating and large-scale through-hole technology components are detrimental, leading to a significant decrease in the efficiency of the electronic transformer and reduced ballast life (and thus reduced lamp life).

There remains a need in the art for an improved light source electronic transformer that exhibits improved heat management, that includes smaller and less expensive circuit components, and that is more efficient and less costly to manufacture.

### SUMMARY OF THE INVENTION

Disclosed are apparatus and methods for providing an advanced thermal management solution that results in a significantly longer lamp life for IC controlled built-in (type) ballast circuit lamps as compared to conventional products. In an embodiment, a lamp includes a light source and an electronic ballast for powering the light source. The electronic ballast includes a main power converter for providing power from a main power line, a controllable starter circuit connected to the main power converter, a transformer connected to the main power converter, a ballast control integrated circuit (IC) connected to the controllable starter circuit and having an output connected to the transformer, and an IC power converter connected to the transformer and having an output connected to the ballast control IC. In operation, when the light source is to be switched ON, the controllable starter circuit receives power from the main power converter and provides a high energy output for input to the ballast control IC circuit. In response to the high energy input the ballast control IC circuit outputs a power control signal to the transformer that causes the light source to illuminate. In addition, the transformer provides supply power to the IC power converter, and wherein after the light source illuminates the controllable starter circuit powers OFF.

In some advantageous embodiments, the IC power converter further comprises a second output connected to the controllable starter circuit and transmits a control signal via the second output at about the same time as the light source illuminates that commands the controllable starter circuit to power OFF. The control signal for powering OFF the controllable starter circuit may be derived from a half bridge circuit, a buffer capacitor or a CSD capacitor.

In some beneficial implementations, the controllable starter circuit includes a time controlled circuit operable to turn the controllable starter circuit OFF. The time controlled circuit may operate to turn OFF the controllable starter circuit after a predetermined amount of time elapses from when a main voltage appears.

The transformer in some embodiments may include a primary coil, a first secondary coil for providing power to illuminate the lamp, and a second secondary coil for providing power to the ballast control IC. In other beneficial embodiments, the transformer may include a primary coil and a single secondary coil, wherein the light source receives power from the secondary coil. In yet another advantageous embodiment, the transformer may include a primary coil and a single secondary coil, wherein the light source receives power from tapped connection to the secondary coil. In addition, in sonic embodiments, the light source may be a halogen-type lamp, an incandescent-type lamp, or an LED-type lamp.

### BRIEF DESCRIPTION OF THE DRAWINGS

FIG. 1 is a schematic circuit diagram of a conventional IC controlled convertor;

FIG. 2 is a block diagram of an IC controlled ballast according to an embodiment of the invention;

FIG. 3 is a schematic diagram of an IC controlled converter according to an embodiment of the invention;

FIG. 3A is a flowchart illustrating a process for controlling the starter circuit of an IC controlled converter according to an embodiment of the invention;

FIG. 4 is a schematic diagram of another IC controlled converter circuit according to another embodiment of the invention;

FIG. 5 is a flowchart of a process for supplying an IC controlled converter circuit according to an embodiment of the invention; and

FIGS. 6, 7 and 8 are schematic diagrams of alternate transformer configurations according to embodiments of the invention.

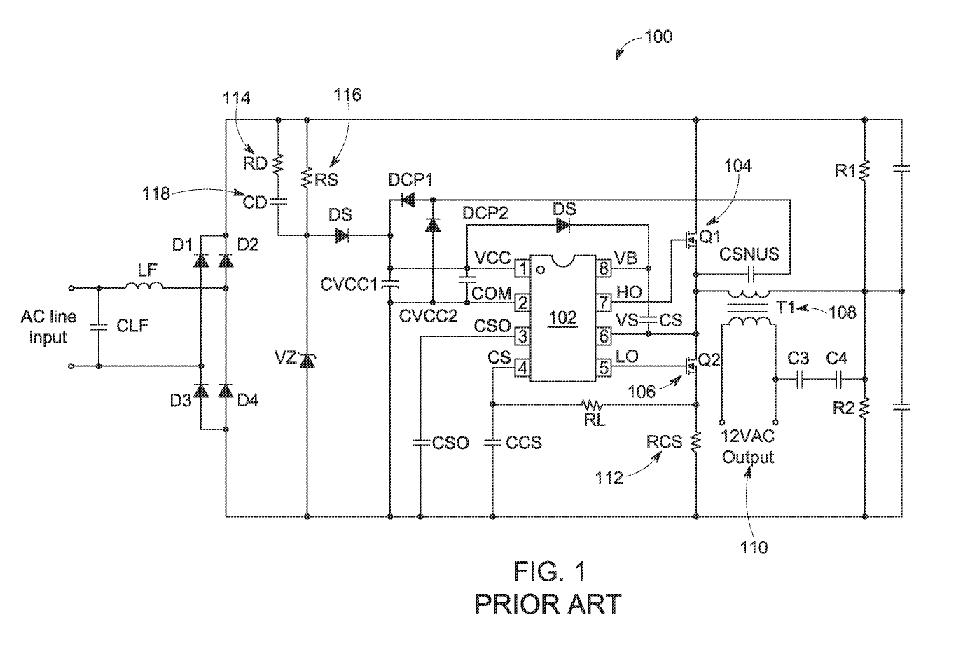

### DETAILED DESCRIPTION

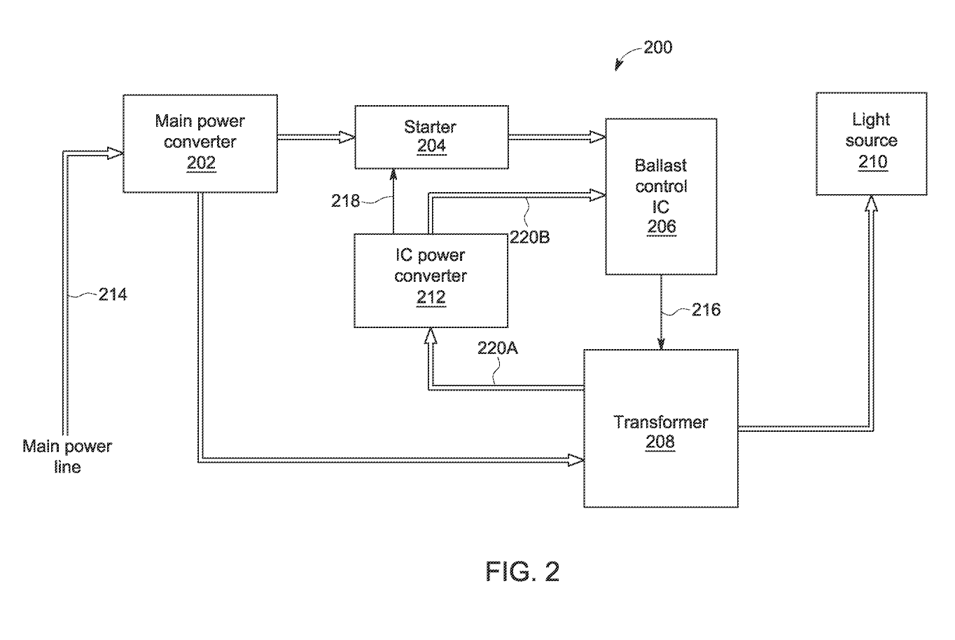

FIG. 2 is a schematic block diagram of an IC controlled ballast 200 in accordance with an embodiment. The ballast 200 includes a main power converter 202, a controllable starter circuit 204, a ballast control IC 206, a transformer 208 connected to the light source 210, and an IC power converter circuit 212. It should be understood that the light source 210 may be an incandescent-type lamp, an LED-type lamp, a halogen-type lamp and the like.

Referring again to FIG. 2, when the lamp is switched ON energy from a main power line 214 is input to the main power converter circuitry 202. Outputs from the main power converter 202 are provided to the starter circuit 204 and to the transformer 208. The controllable starter circuit 204 then begins to operate so as to provide a high-energy input to the ballast control IC circuit 206 so that it will start as quickly as possible. The IC circuit 206 then provides control signals 216 to the transformer 208 that causes the lamp 210 to illuminate, and power is also fed to the IC power converter 212 to supply the Ballast control IC 206. At about the same time as the lamp illuminates, the IC power converter 212 transmits a control signal 218 to the controllable starter circuit 204 that commands the starter circuit 204 to turn OFF. The controllable starter circuit 204 then turns OFF, and thus when the tight source 210 is “ON” then the Ballast control IC 206 is only fed power through the power feedback path 220A (from the transformer 208) and 220B (from the IC power converter 212). Accordingly, during this time the high-dissipating (high heat) electronic components of the controllable starter circuit 204 are not used (turned OFF), which reduces the overall heat dissipation required of the electronic transformer circuitry.

Thus, the controllable starter circuit 204 is utilized to quickly (even if the lamp is in a dimmed state) power up the ballast-control IC 206. When the ballast control IC 206 reaches a stable operation state, the starter circuit 204 turns OFT and the ballast control IC 206 is fed only by the IC power converter circuit 212. Such a circuit configuration and operation is advantageous because, as compared to conventional ballast control IC circuits, smaller-size components can be utilized (which components are less expensive and generate less heat during operation) and a higher overall circuit energy efficiency is obtained. In addition, the lower heat dissipation realized by such components results in a longer ballast lifetime (and thus longer lamp life for built-in type ballast tamp units). Yet further, since small electronic components can be utilized to realize the starter circuit, it is feasible to manufacture a built-in type ballast that is integrated with a lamp (light source).

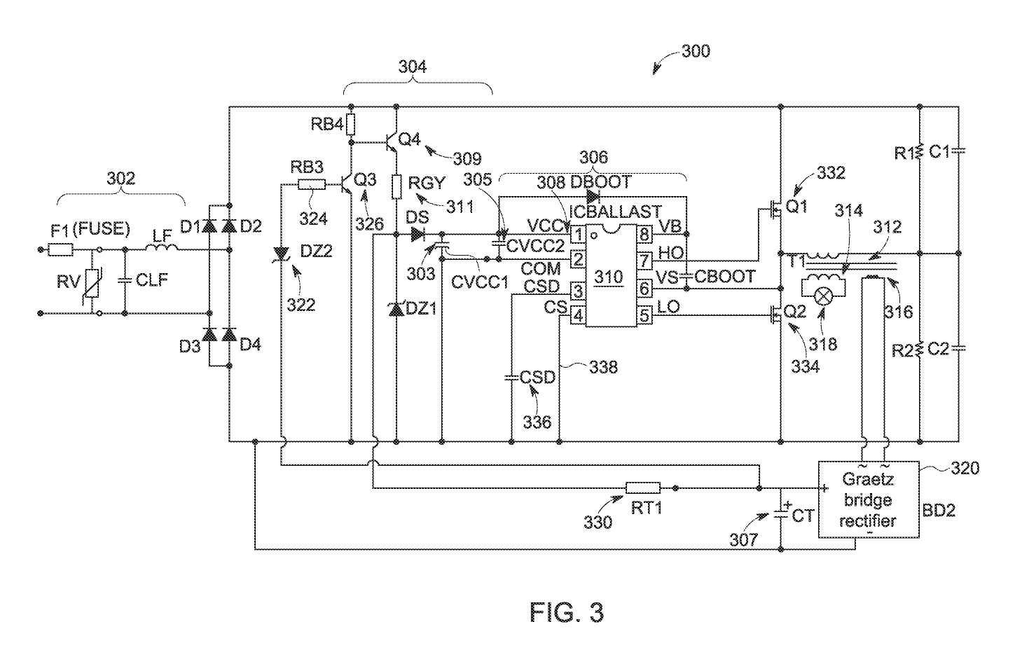

FIG. 3 is a schematic circuit diagram 300 of an IC controlled converter circuit according to an embodiment. Power is provided to the input circuitry 302 when the system is turned on, which then is applied to the controllable starter circuitry 304 to quickly provide energy to the ballast control IC circuitry 306, as described above. It should be understood that the circuit 300 can operate over a wide range of main voltage, including using a 230 VAC main voltage.

Referring again to FIG. 3, when the system is switched ON then CVCC1 303 and CVCC2 305, and CT 307 buffer capacitors are charged by current flowing through the transistor Q4 309 and the resistor RGY 311 (which act as a current source). When the VCC input 308 of the electronic ballast control IC 310 (which in this implementation is an IR2161 integrated circuit) reaches a predetermined threshold value, then the electronic ballast control IC starts to operate and a high-frequency alternating current (AC) appears on the T1 transformer 312. (The T1 transformer 312 has two secondary coils 314 and 316, wherein power from the first secondary coil 314 is utilized to supply a lamp (light source) 318, and current from the second secondary coil 316 is used to feed the ballast control IC 310 through the bridge rectifier BD2 320.) As operation continues, the T1 transformer 312 and the bridge rectifier 320 act as a current source and start to charge the buffer capacitor CT 307, and the voltage across the zener diode DZ2 322 increases to eventually reach a breakdown voltage (zener voltage) of the zener diode. When the breakdown voltage is reached, then current begins to flow through resistor RB3 324 into the base of transistor Q3 326 which starts to conduct, which causes the transistor Q4 309 to turn OFF and thus shuts OFF the starter circuitry 304. Accordingly, when the transistor Q4 309 turns OFF, the electronic ballast control IC 310 is now only fed from the secondary coil 316 of the T1 transformer 312 through the current limiter RT1 330.

Thus, the starter circuitry 304 is now turned OFF after having been ON only for a short period of time. Thus, in contrast to conventional IC ballast control circuit designs wherein the starter circuitry remains ON even after the lamp 318 is illuminated, the present circuitry beneficially turns OFF the starter circuitry 304 when it is no longer needed. This results in less heat that needs to be dissipated from the components and longer component lifetime.

Referring again to FIG. 3, the starter circuitry 304 is a current-driven inverting circuit, and in some embodiments the transistors Q3 326 and Q4 309 are bipolar transistors. But it should be understood that other types of switching circuits could be utilized that use field-effect transistors (FETs), metal-oxide semiconductor filed effect transistors (MOSFETs), and/or other types of switching elements.

In the embodiment shown in FIG. 3, the control signal responsible for shutting OFF the starter circuitry 304 is derived from the buffer capacitor 307. However, in other embodiments the control signal may be derived and/or provided from another part of the electronic ballast circuitry. For example, a control signal could be Obtained from between the half-bridge MOSFETs (metal-oxide field-effect transistors) Q1 332 and Q2 334, even though there is a high voltage between them. In other examples, a control signal may be derived from the CSD capacitor 336, or from the first secondary coil 314. Thus, it is contemplated that a suitable control signal can be derived and/or provided from one or more different parts or portions of the electronic transformer circuitry (including control signals generated by optical sensing, electromagnetic coupling, hail sensing, etc.) that functions to disable the starter circuitry 304 when the lamp is illuminated and thus when the starter operation is no longer needed.

In addition, in some embodiments the Zeiler diode DZ2 322 could be replaced by a series chain of diodes, or by a Diode for Alternating Current (MAC) which conducts current only after its breakdown voltage has been reached momentarily.

Furthermore, in some other embodiments, a delay circuit could be connected to the control signal line.

In yet another example embodiment, the starting circuit 304 could be implemented as a time controlled circuit, which is operable to turn off after a predetermined time elapses from when the main voltage appears on the input circuitry 302. In particular, FIG. 3A is a flowchart illustrating a process 350 for controlling the starter circuit of an IC controlled. converter according to an embodiment. In particular, in step 352 the starter circuit receives 352 power and then it provides 354 a high-energy output to the ballast control IC for a predetermined time (which may be a predetermined fixed time interval, for example, 0.2 seconds). After the predetermined time elapses, a timer circuit (not shown) turns OFF 356 the starter circuit. In such an embodiment, the predetermined time (or time interval) may depend on the main line voltage and/or the dimming level and the like, and is independent of any other part of the ballast circuitry. Thus, in such an embodiment, feedback information from the ballast control IC is not required.

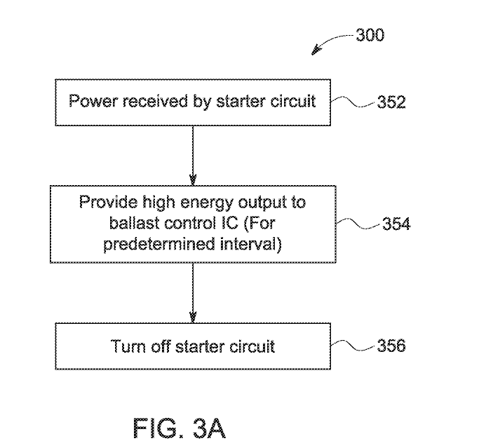

FIG. 4 is a schematic circuit diagram 400 of an IC controlled ballast circuit according to another embodiment. It should be understood that the circuit 400 can operate over a wide range of main voltage, including using a 230 VAC main voltage.

Referring to FIG. 4, power is provided to the input circuitry 402 when the system is switched ON, which then is applied to the controllable starter circuitry 404 to quickly provide energy to the ballast control IC circuitry 406. In particular, when the system is turned ON, then CVCC1 403 and CVCC2 405 buffer capacitors are charged by the current that flows through the transistor Q4 409 and the resistor RGY 411 (which act as a current source). When the VCC input 408 reaches a specified limit, the ballast control IC 410 starts to operate, and a high frequency alternating current (AC) appears on the T1 transformer 412. The T1 transformer 412 has two secondary coils 414 and 416, wherein power from the first secondary coil 414 supplies the lamp 418, and current from the second secondary coil 416 is fed back to the ballast control IC 410 through the bridge rectifier circuit BD2 420.

As operation continues, the T1 transformer 412 and the bridge rectifier BD2 420 act as a current source and start to charge the buffer capacitor CT 407. When the voltage across the buffer capacitor CT 407 reaches a predetermined limit, the base current of the transistor Q3 426 is high enough to turn OFF the transistor Q4 409. At this point, the starter circuitry 404 is OFF and the ballast control IC 410 is only fed from the secondary coil 416 of T1 transformer 412 via the bridge rectifier circuit 420, diode DT 428 and current limiter RT1 430. Accordingly, if a quick main voltage switch occurs (such as a “turn ON→turn OFF→turn ON” process), the ballast circuitry will not supply power to the lamp 418 until the voltage across the CT capacitor 407 decreases to under a certain limit. The amount of this time delay can be chosen by the appropriate selection of the values for the resistor RT2 422 and for the CT capacitor 407, In addition, in some embodiments if the current limiter RT1 430 is designed to have a high resistance, it may be possible to eliminate the diode DT 428 from the circuit (however, in such a case low dimming is not acceptable, that is dimming problems can occur).

Referring again to FIG. 4, the starter circuitry 404 is a current-driven inverting circuit, and in some embodiments the transistors Q3 326 and Q4 328 are bipolar transistors. But it should be understood that other types of switching circuits could be utilized that use field-effect transistors (FETs), metal-oxide semiconductor filed effect transistors (MOSFETs), and/or other types of switching elements.

In the embodiment discussed above with regard to FIG. 4, the control signal responsible for shutting OFF the starter circuitry 404 is derived from the capacitor CT 407, However, it is contemplated that the control signal may be derived and/or provided from another part of the electronic ballast circuitry. For example, a control signal could be obtained from between the half-bridge MOSFETs (transistors) Q1 432 and Q2 434, even though there is a high voltage between them. In other examples, a control signal may be derived from the capacitor CSD 436, or from the first secondary coil 414. Thus, it is contemplated that a suitable control signal can be derived and/or provided from one or more different parts or portions of the electronic transformer circuitry (including generating a control signal by optical sensing, electromagnetic coupling, hall sensing, and the like) that functions to disable the starter circuitry 404 when the lamp is illuminated and thus when the starter operation is no longer required.

In addition, in some embodiments of the ballast control IC circuit 400, a Zener diode in series with the resistor RB3 424 may be utilized to operate in the manner described above with regard to FIG. 3. Such a Zener diode could be replaced by a series chain of diodes, or by a Diode for Alternating Current (DIAC) which conducts current only after its breakdown voltage has been reached momentarily.

In another alternative design, a delay circuit could be connected to the control signal line.

In yet another example embodiment, the starting circuit 404 could be implemented as a time controlled circuit, which is operable to turn OFF after a predetermined time elapses from when the main voltage appears on the input circuitry 402. In particular, referring again to FIG. 3A, the process 350 for controlling the starter circuit of an IC controlled converter according to an embodiment could also be utilized with regard to the circuitry of FIG. 4. In such an embodiment, the predetermined time (or time interval) may depend on the main line voltage and/or the dimming level and the like, and it is independent of any other part of the ballast circuitry. Thus, in such an embodiment, feedback information from the ballast control IC is not required.

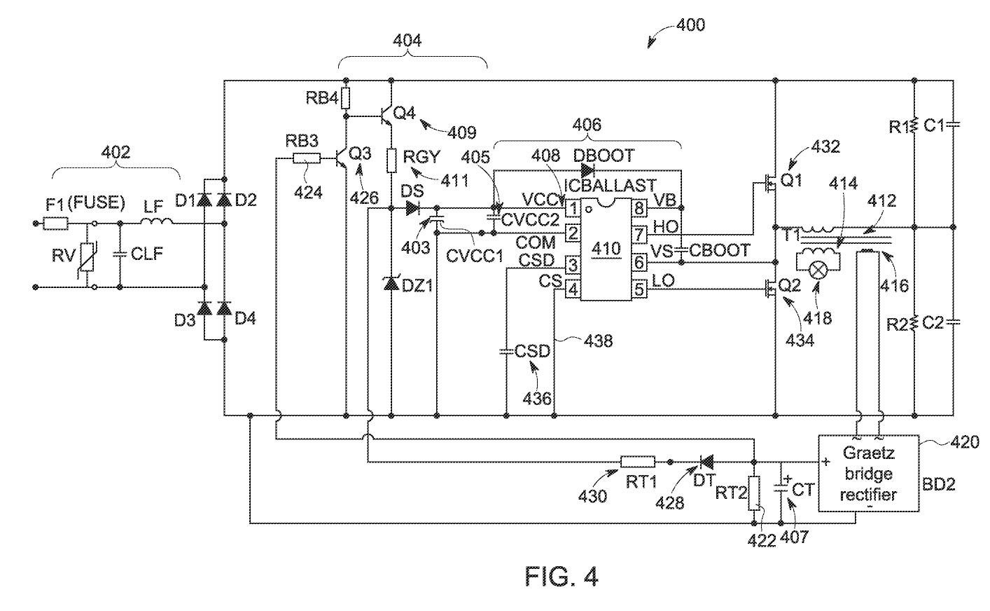

FIG. 5 is a flowchart of a process 500 for supplying an IC controlled converter according to an embodiment. The process begins when a starter circuit receives 502 power, which may be from a main power converter, to initiate the process for illuminating a lamp. Next, the starter circuit provides 504 a high energy output for input to a ballast control IC circuit. The ballast control IC functions to provide power to the lamp, and then if the starter circuit receives 506 a control signal, then the starter circuit turns OFF 508 and the process ends. However, if in step 506 the starter circuit does not receive a control signal, then the process branches back to step 504 and the starter circuit continues to supply the high energy output for input to the ballast control IC.

It is also contemplated that the circuitry shown in FIGS. 3 and 4 herein may be implemented as a built-in type IC controlled. converter (that is, built-in to a lamp unit), or may be implemented as an external-type IC controlled converter (separate from a lamp or light source). In addition, the circuitry of FIGS. 3 and 4 may be configured to utilize two separate transformers in place of a single T1 transformer (reference 312 in FIG. 3 and reference 412 in FIG. 4). in such a case, the first transformer could be utilized for illuminating the lamp (318 or 418) while the second transformer could be responsible for supplying the ballast control IC circuitry. Such a circuit configuration may be more costly than those presented above, but may be desirable if the layout design requires it.

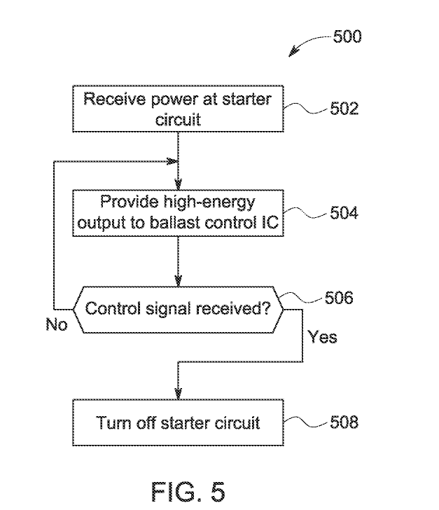

Yet further, the circuitry shown in FIGS. 3 and 4 herein may incorporate alternate transformer designs for supplying power to a light source and to the ballast control IC. For example, FIG. 6 illustrates an alternate transformer configuration 600 according to an embodiment. In particular, the T1 transformer 612 has only a single secondary coil 614 (rather than two secondary coils 314 and 316 shown in FIG. 3, or 414 and 416 shown in FIG. 4). In such a case, the light source 618 and the bridge rectifier BD2 620 are both connected to the same secondary coil 614, so that the light source 618 and the ballast control IC (not shown) are both supplied from the same secondary coil 614. However, in this case, the light source 618 is not galvanically isolated as it is in the circuit designs of FIGS. 3 and 4.

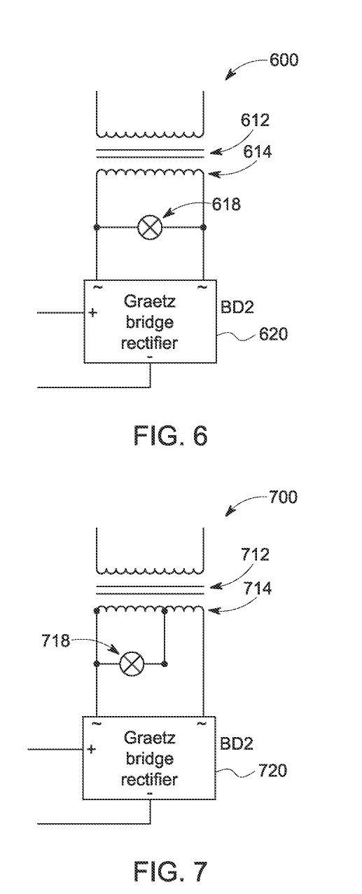

In another example, FIG. 7 illustrates an alternate transformer configuration 700 according to an embodiment As in the configuration 600 of FIG. 6, the T1 transformer 712 has only a single secondary coil 714 (rather than two secondary coils 314 and 316 shown in FIG. 3, or 414 and 416 shown in FIG. 4). However, in this case, the light source 718 has a tapped connection to the secondary coil 714, whereas the bridge rectifier BD2 720 is connected via the full secondary coil 714. In this case, the number of turns of the transformer secondary coil depends on the voltage required by the tight source 718 and the ballast control IC (not shown), which are both supplied from the same secondary coil 714. Once again, the light source 718 is not galvanically isolated as it is in the circuit designs of FIGS. 3 and 4.

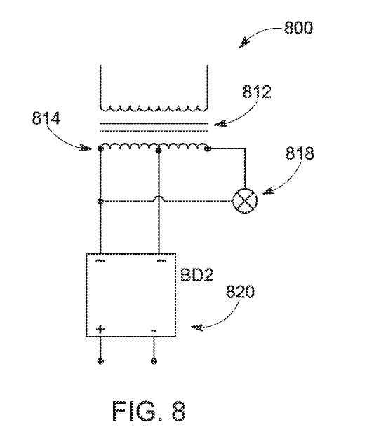

In yet another example, FIG. 8 illustrates an alternate transformer configuration 800 according to an embodiment. As in the configurations 600 of FIG. 6 and 700 of FIG. 7, the T1 transformer 812 has only a single secondary coil 814 (rather than two secondary coils 314 and 316 shown in FIG. 3, or 414 and 416 shown in FIG. 4). However, in this case, the bridge rectifier BD2 820 has a tapped connection to the secondary coil 814, whereas the light source 818 is connected via the full secondary coil 814. The number of turns of the transformer secondary coil depends on the voltage required by the light source 818 and the ballast control IC (not shown), which are both supplied from the same secondary coil 814. In addition, the light source 818 is not galvanically isolated as it is in the circuit designs of FIGS. 3 and 4,

Thus, the IC controlled converter and methods described herein provide for the application of smaller-sized and less expensive circuit components, improved heat management, and higher efficiency than conventional designs. The advanced thermal management solution provided herein results in a significantly longer lamp life for a lamp having an IC controlled built-in ballast. In addition, better power efficiency and a more reliable product is achieved as compared to conventional products.

The above description and/or the accompanying drawings are not meant to imply a fixed order or sequence of steps for any process referred to herein; rather any process may be performed in any order that is practicable, including but not limited to simultaneous performance of steps indicated as sequential.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A lamp, comprising:
a light source; and
an electronic ballast for powering the light source, wherein the electronic ballast comprises:
a main power converter for providing power from a main power line;
a controllable starter circuit connected to the main power converter;
a transformer connected to the main power converter;
a ballast control integrated circuit (IC) connected to the controllable starter circuit and having an output connected to the transformer; and
an IC power converter connected to the transformer and having an output connected to the ballast control IC;
wherein, when the light source is to be switched ON, the controllable starter circuit receives power from the main power converter and provides a high energy output for input to the ballast control IC circuit, and wherein in response to the high energy input the ballast control IC circuit outputs a power control signal to the transformer that causes the light source to illuminate and the transformer to provide supply power to the IC power converter, and wherein after the light source illuminates the controllable starter circuit powers OFF.

2. The lamp of claim 1, wherein the IC power converter further comprises a second output connected to the controllable starter circuit and transmits a control signal via the second output at about the same time as the light source illuminates that commands the controllable starter circuit to power OFF.

3. The lamp of claim 2, wherein a control signal for powering OFF the controllable starter circuit is derived from at least one of a half bridge circuit, a buffer capacitor, a CSD capacitor and a light source.

4. The lamp of claim 1, wherein the controllable starter circuit further comprises a time controlled circuit operable to turn the controllable starter circuit OFF.

5. The lamp of claim 4, wherein the time controlled circuit operates to turn OFF the controllable starter circuit after a predetermined amount of time elapses from when a main voltage appears.

6. The lamp of claim 1, wherein the transformer comprises a primary coil, a first secondary coil for providing power to illuminate the lamp, and a second secondary coil for providing power to the ballast control IC.

7. The lamp of claim 1, wherein the transformer comprises a primary coil and a single secondary coil, and wherein the light source receives power from the secondary coil.

8. The lamp of claim 1, wherein the transformer comprises a primary coil and a single secondary coil, and wherein the light source receives power from tapped connection to the secondary coil.

9. The lamp of claim 1, wherein the light source comprises at east one of a halogen-type lamp, an incandescent-type lamp, or an LED-type lamp.

10. An electronic ballast for powering a light source, comprising:
a main power converter for providing power from a main power line;
a controllable starter circuit connected to the main power converter;
a transformer connected to the main power converter and to an associated light source;
a ballast control integrated circuit (IC) connected to the controllable starter circuit and having an output connected to the transformer; and
an IC power converter connected to the transformer and having an output connected to the ballast control IC;
wherein, when the light source is to be switched ON, the controllable starter circuit receives power from the main power converter and provides a high energy output for input to the ballast control IC circuit, and wherein in response to the high energy input the ballast control IC circuit outputs a power control signal to the transformer that causes the light source to illuminate and the transformer to provide supply power to the IC power converter, and wherein after the light source illuminates the controllable starter circuit powers OFF.

11. The ballast of claim 10, wherein the IC power converter further comprises a second output connected to the controllable starter circuit and transmits a control signal via the second output at about the same time as the light source illuminates that commands the controllable starter circuit to power OFF.

12. The ballast of claim 11, wherein a control signal for powering OFF the controllable starter circuit is derived from at least one of a half bridge circuit, a buffer capacitor, a CSD capacitor and a light source.

13. The ballast of claim 10, wherein the controllable starter circuit further comprises a time controlled circuit operable to turn the controllable starter circuit OFF.

14. The ballast of claim 13, wherein the time controlled circuit operates to turn OFF the controllable starter circuit after a predetermined amount of time elapses from when a main voltage appears.

15. The ballast of claim 10, wherein the transformer comprises a primary coil, a first secondary coil for providing power to illuminate the light source, and a second secondary coil for providing power to the ballast control IC.

16. The ballast of claim 10, wherein the transformer comprises a primary coil and a single secondary coil, and wherein a light source receives power from the secondary coil.

17. The ballast of claim 10, wherein the transformer comprises a primal coil and a single secondary coil, and wherein a light source receives power from tapped connection to the secondary coil.

18. The ballast of claim 10, wherein the light source comprises at least one of a halogen-type lamp, an incandescent-type lamp, or an LED-type lamp.

19. A method for controlling an electronic ballast for a light source, comprising:
receiving, by a starter circuit, power from a main power converter to initiate illumination of a light source;
providing, by the starter circuit, a high energy output for input to a ballast control IC;
receiving, by the starter circuit, a control signal; and
powering OFF the starter circuit in response to the control signal.

20. The method of claim 19, wherein receiving power further comprises receiving, by a transformer, power from the main power converter.

21. The method of claim 19, subsequent to providing the high energy output, transmitting, by the ballast control IC, a power signal to enable a transformer to provide power to illuminate the light source.

22. The method of claim 21, further comprising transmitting, by the transformer, power to an IC power converter.

23. The method of claim 22, further comprising:
transmitting, by the IC power converter, the control signal to the starter circuit; and
transmitting, by the IC power converter, supply power to the ballast control IC.

24. A method for controlling an electronic ballast for a light source, comprising:
receiving, by a starter circuit, power from a main power converter to initiate illumination of a light source;
providing, by the starter circuit, a high energy output for input to a ballast control IC;
receiving, by the starter circuit, a control signal from a time controlled circuit; and
powering OFF the starter circuit in response to the control signal.

25. The method of claim 24, wherein the time controlled circuit generates the control signal after a predetermined amount of time elapses from when a main voltage appears.
